(19) United States
(12) Patent Application Publication
(10) Pub. No.: US 2007/0052224 A1
(43) Pub. Date: Mar. 8, 2007

(54) Gas generator

(75) Inventors: Masayuki Nakayasu, Tatsuno-Shi (JP); Masayuki Ueda, Tokyo (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/514,107

(22) Filed: Sep. 1, 2006

Related U.S. Application Data
(60) Provisional application No. 60/714,896, filed on Sep. 8, 2005.
(60) Provisional application No. 60/727,483, filed on Oct. 18, 2005.

(30) Foreign Application Priority Data
Sep. 5, 2005 (JP) 2005-256090
Oct. 13, 2005 (JP) 2005-298380

(51) Int. Cl. B60R 21/26

(52) U.S. Cl. 280/740; 280/728.1; 280/737

(57) ABSTRACT

The present invention relates to gas generator for a restraining device of a vehicle, including a cylindrical housing having two opening portion, an ignition device chamber connected to one opening portion of the cylindrical housing, a diffuser portion connected to the other opening portion of the cylindrical housing and having a gas discharge port, a first blockage member blocking between the cylindrical housing and the ignition device chamber, a second blockage member blocking between the cylindrical housing and the diffuser portion, a pressurized gas charged inside the cylindrical housing, a rod, which breaks the second blockage member to open a path to the diffuser portion during activation, being disposed inside the cylindrical housing, the base portion of the rod being in contact with a wall surface near the first blockage member, a distal end portion of the rod being in contact with and supported by a retainer which is fitted into a position near the second blockage member, the distal end portion of the rod and the retainer being fixed by pressing against each other due to the distal end portion of the rod contacting and supported by the retainer, the base portion of the rod being fixed by pressing against the wall surface near the first blockage member because of the distal end portion of the rod and the retainer fixing to each other.

This nonprovisional application claims priority under 35 U.S.C. §119(a) on Patent Applications No. 2005-256090 filed in Japan on 5 Sep. 22005 and No. 2005-298380 filed in Japan on 13 Oct. 2005, and 35 U.S.C. §119(e) on U.S. Provisional Applications No. 60/714896 filed on 8 Sep. 2005 and No. 60/727483 filed on 18 Oct. 2005, which are incorporated by reference.

### BACKGROUND OF THE INVENTION

1. Field of the Invention

The present invention relates to a gas generator for use in an occupant restraining device for a vehicle, such as an air bag, an inflatable seat belt, and a pedestrian protection device.

2. Description of Related Art

In a gas generator that inflates an air bag or the like in a vehicle occupant restraining device or a pedestrian protection device, the preferred structure is that, no igniter connected to a lead wire for ignition, which becomes an obstacle for bag connection, exists in the vicinity of the gas discharge port because an air bag (restraining device) is connected to a gas discharge outlet.

U.S. Pat. No. 3,856,180 discloses an inflator using a pressurized gas in which an igniter and a gas discharge port are separated. In a gas generator using a pressurized gas, a rupturable plate is employed as blockage member for blocking the gas discharge port, but during the actuation, the rupturable plate has to be ruptured to open the gas discharge path. In U.S. Pat. No. 3,856,180, such a structure is employed that a rupturable plate is ruptured by a rod actuated by a high-temperature high-pressure gas generated by the actuation of ignition device.

In the invention of U.S. Pat. No. 3,8.56,180, a squib 44 is attached to one end of an inflator container 12 accommodating the pressurized gas. The squib 44 is also attached to one end portion of a combustion chamber 16 formed in one end portion of the housing 12 and the squib is disposed inside the housing 12. A gas generating agent 34 that is ignited by the actuation of squib 44 and generates the high-temperature and high-pressure gas is disposed in the combustion chamber 16, and the generated gas pushes the rod 74 to the right to rupture a seal 80 serving as a rupturable plate. The rod is fixed by being supported on a sleeve 76 attached to the seal 80. In the gas generator of such structure, in order to provide for reliable actuation, the fixed position of the rod has to be prevented from shifting under the effect of external impacts of vibrations.

### SUMMARY OF THE INVENTION

The present invention provides a gas generator for a restraining device of a vehicle, including:

a cylindrical housing having two opening portions,

an ignition device chamber connected to one opening portion of the cylindrical housing,

a diffuser portion connected to the other opening portion of the cylindrical housing and having a gas discharge port,

a first blockage member blocking between the cylindrical housing and the ignition device chamber,

a second blockage member blocking between the cylindrical housing and the diffuser portion,

a pressurized gas charged inside the cylindrical housing,

a rod, which breaks the second blockage member to open a path to the diffuser portion during activation, being disposed inside the cylindrical housing, the base portion of the rod being in contact with a wall surface near the first blockage member, and

a distal end portion of the rod being in contact with and supported by a retainer which is fitted into a position near the second blockage member,

the distal end portion of the rod and the retainer being fixed by pressing against each other due to the distal end portion of the rod contacting and supported by the retainer, the base portion of the rod being fixed by pressing against the wall surface near the first blockage member due to the distal end portion of the rod and the retainer fixing to each other.

In other words, the invention is a gas generator for a restraining device of a vehicle, including:

a cylindrical housing having two opening portions, an ignition device chamber connected to one opening portion of the cylindrical housing, and a diffuser portion connected to the other opening portion of the cylindrical housing and having a gas discharge port, wherein

a channel between the cylindrical housing and the ignition device chamber is blocked with first blockage member, a channel between the cylindrical housing and the diffuser portion is blocked with second blockage member, and a pressurized gas is loaded into the cylindrical housing,

inside the cylindrical housing, a rod for breaking the second blockage member and opening the channel to the diffuser portion during actuation is disposed in a state where a base portion thereof is brought into contact with a wall surface in the vicinity of the first blockage member and a distal end portion is brought into contact with and supported by a retainer fitted in a position close to the second blockage member, and

the distal end portion of the rod is brought into contact with and supported by the retainer, whereby the distal end portion of the rod and the retainer are fixed by being pressed against each other, and because the distal end portion of the rod and the retainer are fixed to each other, the base portion of the rod is pressed against and fixed to the wall surface in the vicinity of the first blockage member.

The invention further provides a gas generator for an occupant-restraining device of a vehicle, including:

a cylindrical housing having two opening portions,

an ignition device chamber connected to one opening portion of the cylindrical housing,

a diffuser portion connected to the other opening portion and having a gas discharge port,

a first channel being formed between the cylindrical housing and the ignition device chamber and blocked by a first blockage member,

a second channel being formed between the cylindrical housing and the diffuser portion and blocked by a second blockage member,

a pressurized gas being charged inside the cylindrical housing,

a rod, which breaks the second blockage member to open a path to the diffuser portion during activation, being disposed inside the cylindrical housing,

a base portion of the rod being in contact with a wall surface near the first blockage member,

a distal end portion of the rod being in contact with and supported by a retainer which is fitted into a position near the second blockage member,

a retainer including an annular flame portion abutting against an inner circumferential surface of the cylindrical housing, and

a central support portion abutting against the distal end portion of the rod, and a rod-like support portion connecting the annular flame portion with the central support portion,

the rod being fixed in a state of contacting the retainer by the distal end thereof and the retainer pressing against each other due to elastic deformation of at least one portion among the annular flame portion, the central support portion and rod-like support portion, further, the base portion of the rod being pressed against and fixed to a wall surface near the first blockage member by the distal end portion of the rod and the retainer fixed to each other.

In other words the invention is a gas generator for an occupant restraining device for a vehicle, including:

a cylindrical housing having two opening portions, an ignition device chamber connected to one opening portion of the cylindrical housing, and a diffuser portion connected to the other opening portion of the cylindrical housing and having a gas discharge port, wherein

a first channel between the cylindrical housing and the ignition device chamber is blocked with first blockage member, a second channel formed between the cylindrical housing and the diffuser portion is blocked with second blockage member, and a pressurized gas is loaded into the cylindrical housing,

inside cylindrical housing, a rod for breaking the second blockage member and opening the channel to the diffuser portion during actuation is disposed in a state where a base portion thereof is brought into contact with a wall surface in the vicinity of the first blockage member and a distal end portion is brought into contact with and supported by a retainer fitted in a position close to the second blockage member,

the retainer has an annular frame portion that comes into contact with an inner circumferential surface of the cylindrical housing, a central support portion that comes into contact with the distal end portion of the rod, and a rod-like support portion connecting the annular frame portion and the central support portion, and

in a state where the rod is in contact with the retainer, the distal end portion of the rod and the retainer are fixed by being pressed against each other by elastic deformation of any one of the annular frame portion, the central support portion, and the rod-like support portion, and because the distal end portion of the rod and the retainer are fixed to each other, the base portion of the rod is pressed against and fixed to the wall surface in the vicinity of the first blockage member.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 shows a longitudinal sectional view of a gas generator for an air bag;

FIG. 2 shows a perspective view of the retainer shown in FIG. 1;

FIG. 3 shows a perspective view of the retainer of another embodiment;

FIG. 4 shows a perspective view of the rod and retainer of another embodiment;

FIG. 5 shows a longitudinal sectional view of a gas generator for an air bag of another embodiment;

FIG. 6 shows a longitudinal partial sectional view of a gas generator for an air bag of another embodiment; and

FIG. 7 is a perspective view of the retainer shown in FIG. 6.

### DETAILED DESCRIPTION OF THE INVENTION

In the inflator of U.S. Pat. No. 3,856,180, the end portion of the rod 74 is supported inside the split sleeve 76 by friction, but the diameter of rod. 74 is almost constant, the sleeve 76 is fixed to the seal 80 merely by being supported inside the counter bore 78, the sleeve 76 can be displaced by the external vibrations, and the rod 74 is fixed insufficiently.

The present invention is to provide a gas generator for a restraining device for a vehicle that has a structure in which an igniter and a gas discharge port are provided in separate positions and the blockage member of a gas discharge channel leading to the gas discharge port is broken by a rod, wherein the rod is fixed by a simple structure.

When the gas generator is actuated, the first blockage member is broken by the ignition device, and the second blockage member is broken by the rod, whereby a gas discharge channel leading to the gas discharge port is opened. As a result, the restraining device is actuated, that is, the air bag is inflated and so on. From the standpoint of ensuring the safety of vehicle occupants, the above-described operation has to be reliably conducted over a period of 10 years or more, which is a service life of a vehicle, and vibrations provided from the outside should not displace or shift the rod to disturb breaking of the second blockage member.

In accordance with the present invention, the distal end portion of the rod is brought into contact with and supported by the retainer, whereby they are fixed to each other. Furthermore, because the distal end portion of the rod and the retainer are fixed to each other, the base portion of the rod is pressed against and fixed to the wall surface in the vicinity of the first blockage member. Therefore the rod is supported at the distal end portion and base portion and is thereby prevented from falling out or being separated.

The contact state of the distal end portion of the rod and the retainer, can be, for example, a state in which the rod and retainer are pressed against each other, more specifically a state where the rod is pressed against a surface of the retainer or a state in which the rod pierces the retainer. In other words, the retainer is disposed to press the rod against the wall surface in the vicinity of the first blockage member, and conversely the rod is disposed to be pressed against the retainer (however, part of the retainer abuts against and fixed to, e.g., the inner surface of the housing so that the retainer is prevented from moving under the effect of pressure applied by the rod inside the housing).

Prior to actuation, the distal end portion of the rod is disposed with a gap for the second blockage member. During actuation, the rod breaks the retainer, which is in contact therewith, and linearly advances, thereby breaking the second blockage member. Because of the gap between distal end of the rod and the second blockage member, an initial velocity is generated when the rod comes into contact with the second blockage member, whereby the second blockage member, can be broken easier.

The cylindrical housing has a cylindrical outer shape, but no limitation is placed on the position of the two opening portions, and the two opening portions may be provided at both ends, or in the circumferential surface, or at one end and in the circumferential surface.

A well-known electric igniter can be used as the ignition device, and if necessary, a well-known transfer charge or gas generating agent can be used together with the electric igniter as the ignition device.

The blockage member is not particularly limited if it can withstand a pressure inside the cylindrical housing and maintain in an air-tight state, and a rupturable plate, composed of a round plate from stainless steel or the like and used conventionally in a hybrid inflator, may be employed.

The retainer is not particularly limited if it can be disposed inside the cylindrical housing and may support the distal end portion of the rod. For example, an elastic annular retainer matching the inner shape of the cylindrical housing can be used.

The annular retainer is preferably provided with a fragile portion in the portion that is brought into contact with the distal end portion of the rod, so that the portion holding the distal end portion of the rod will be reliably broken by a smaller force during actuation. The fragile portion may be a portion thinner than other portions, a portion provided with a notch or having a groove provided therein, a protrusion (hook), an orifice, or the like and serves to be deformed, ruptured, and broken by the force applied thereto, thereby allowing the rod to move toward the second blockage member.

The rod may have a uniform diameter, or parts thereof may have different diameters, or the diameter may decrease gradually from the base portion to the distal end portion. The rod can have a round or polygonal cross portion. The distal end of the rod is preferably tipped so that the second blockage member can be easily broken, but it may be rounded or in the form of a flat surface.

The present invention preferably relates to the gas generator for a restraining device of a vehicle, wherein

the retainer has at least one orifice or recess, and

the distal end portion of the rod is inserted into the orifice or recess of the retainer, whereby the distal end portion of the rod and the retainer are fixed by pressing against each other, and the distal end portion of the rod and the retainer are fixed to each other, whereby the base portion of the rod is pressed against and fixed to the wall surface in the vicinity of the first blockage member.

The distal end portion of the rod is inserted into and brought into contact with the orifice (through orifice) or recess of the retainer (an indent having a side surface and a bottom surface), whereby the distal end portion of the rod and the retainer are fixed by pressing against each other. The size of the orifice or recess of the retainer are set so as to prevent the rod from moving in the direction of the second blockage member prior to actuation. A fragile portion is preferably provided around the orifice, and in the case of a recess, the bottom surface itself or the bottom surface and the side surface themselves serve as the fragile portion. From the standpoint of further reducing the breaking energy, an orifice is preferred.

The present invention preferably relates to the gas generator for a restraining device, wherein

the rod has a shaft portion and a distal end portion, and the distal end portion of the rod has a reduced diameter portion having a diameter smaller than that of the shaft portion of the rod, and

the rod is inserted into the orifice or recess of the retainer so that only the reduced diameter portion protrudes toward the diffuser portion, and the remaining portion of the rod presses against the orifice or recess of the retainer, whereby the distal end portion of the rod and the retainer are fixed by pressing against each other, and the distal end portion of the rod and the retainer are fixed to each other, whereby the base portion of the rod is pressed against and fixed to the wall surface in the vicinity of the first blockage member.

The distal reduced diameter portion can have a cone-like, tipped, or rod-like shape. Such distal reduced diameter portion (a portion having a diameter smaller than that of the remaining portion; the remaining portion having a larger diameter is termed a large-diameter portion) is provided at the distal end portion of the rod, the distal reduced diameter portion is inserted into the orifice or recess of the retainer, and the fixing strength of the distal end of the rod and the retainer is increased by pressing against the orifice or recess from the circumference of the large-diameter portion.

When a step is provided in the large-diameter portion of the rod and the distal reduced diameter portion is inserted into the orifice or recess, the circumference of the orifice or recess may be pressed by the stepped surface. At this time, the portion coming into contact with the stepped surface can be made a fragile portion.

The present invention preferably relates to the gas generator for a restraining device, wherein the retainer has an annular frame portion, a plurality of rod-like support portions extending toward a center from a peripheral edge on one end side of the annular frame portion, and a central support portion formed by the plurality of support portions and having an orifice or a recess, wherein a circumferential surface of the annular frame portion is in contact with an inner wall surface of the cylindrical housing.

With the present invention, the rod is prevented from being separated and displaced by the external vibrations and from breaking the second blockage member. When the distal end portion of the rod is fixed by the retainer, the distal end portion of the rod is pushed toward the first blockage member by an elastic force created by the elastic deformation of the retainer.

Because the retainer has an opening portion surrounded by the annular frame portion, central support portion, and rod-like support portions, an elastic force is easily generated by the central support portion, rod-like support portions, and annular frame portion. Under the effect of this elastic force, at least one portion of the annular frame portion, central support portion, and rod-like support portions is bent toward the second blockage member inside the cylindrical housing, and the rod is pushed towards the first blockage member by the reaction force thereof. Because the retainer is thus used, the rod can be readily fixed by introducing or press-inserting into the cylindrical housing and using an elastic force. Furthermore, because the retainer has the opening portion, the weight thereof can be reduced.

The central support portion is not required to be formed in the central portion of the retainer and the thickness or width of the rod-like support portions is not required to be constant as long as the effect of the present invention is demonstrated.

The present invention preferably relates to the gas generator for a restraining device, wherein the central support portion has at least one orifice or recess, and the distal end portion of the rod is inserted into the orifice or recess of the central support portion, whereby the distal end portion of the rod and the retainer are fixed by pressing against each other, and because the distal end portion of the rod and the retainer are fixed to each other, the base portion of the rod is pressed against and fixed to the wall surface in the vicinity of the first blockage member.

The distal end portion of the rod is inserted into and brought into contact with the orifice (through orifice) or recess (an indent having a side surface and a bottom surface) formed in the central support portion, whereby the distal end portion of the rod and the retainer are fixed by pressing against each other. The size of the orifice or recess of the retainer are set so as to prevent the rod from moving in the direction of the second blockage member prior to actuation. A fragile portion is preferably provided around the orifice, and in the case of a recess, the bottom surface itself or the bottom surface and the side surface themselves serve as the fragile portion. From the standpoint of further reducing the breaking energy, an orifice is preferred.

The present invention preferably relates to the gas generator for a restraining device, wherein a total open surface area of an opening portion surrounded by the central support portion, the annular frame portion, and the rod-like support portion is larger than a total open surface area of the gas discharge port formed in the diffuser and a cross-sectional area of the second channel.

Because the retainer can deform when the rod passes through during actuation, the surface area of the opening portion formed in the retainer is difficult to control strictly. However, the gas discharge port of the diffuser portion and second gas channel are not hit or deformed by the retainer, and the amount of discharged gas can be adjusted by changing the diameter or number of the discharge ports and channel diameter. Incidentally, the total open surface area of the gas discharge ports formed in the diffuser and the cross-sectional area of the second channel are set smaller than the area of the opening portion of the retainer, thereby adjusting the amount of discharged gas. Any of the total open area of the gas discharge ports formed in the diffuser and the cross-sectional area of the second channel maybe reduced.

In the gas generator in accordance with the present invention, with a simple structure combining a rod and a retainer, the two can be fixed by pressing against each other. As a result, the rod and retainer are prevented from shifting and falling out under the effect of vibrations applied from the outside.

### Embodiments of the Invention

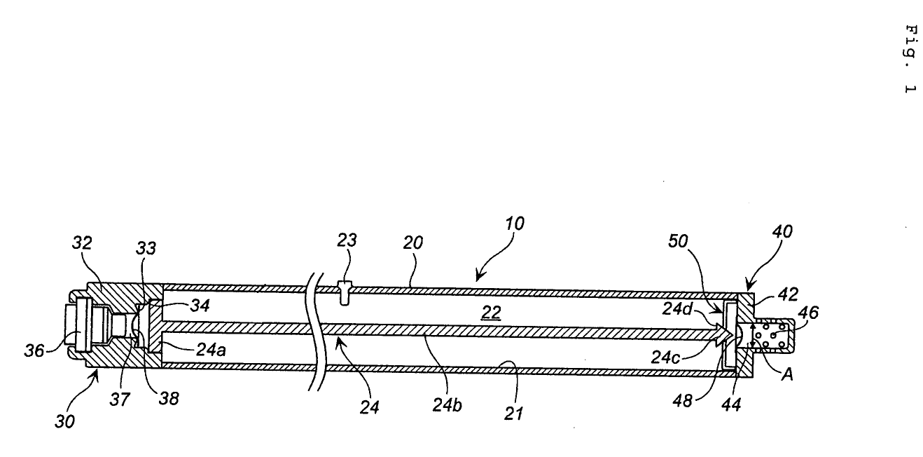

(1) Gas Generator Shown in FIGS. 1 to 3.

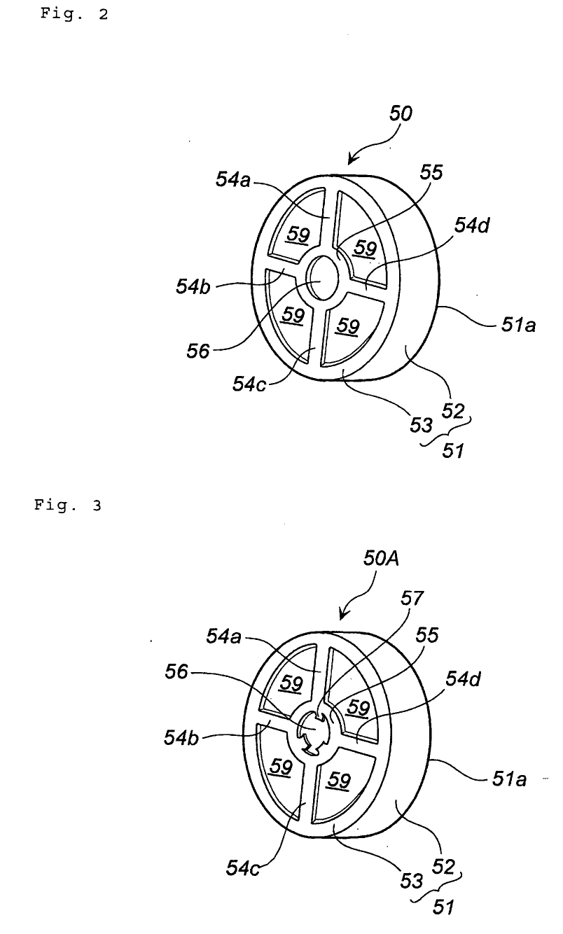

FIG. 1 is a longitudinal sectional view of a gas generator 10 for an airbag. FIG. 2 is a perspective view of a retainer shown in FIG. 1. FIG. 3 is a perspective view of the retainer of in an embodiment different from that shown in FIG. 1. The gas generator shown in FIG. 1 is a stored-gas type using a pressurized gas as an air bag inflation means.

A cylindrical housing 20 has two opening portions on both ends thereof, an ignition device chamber 30 connected to the opening portion at one end, and a diffuser portion 40 connected to the opening portion at the other end. Those components are made from stainless steel or aluminum, and fixed by welding in the respective joint portions thereof.

The inner space 22 of the cylindrical housing 20 is maintained in an air-tight state and filled with argon, helium, nitrogen, or a gas mixture thereof (the charging pressure is about 35,000-70,000 kPa). The pressurized gas preferably has a sound velocity of 400 m/sec or more at a temperature of 0° C. and under a pressure of 1 atm (101.325 kPa). The pressurized gas is charged from a charging hole before it is sealed with a pin 23, and then sealing is conducted by welding the pin 23 and cylindrical housing 20 together.

The ignition device chamber 30 has an outer shell formed by an ignition device chamber housing 32. An electric igniter 36 provided with an ignition agent is accommodated inside the ignition device chamber housing 32. The igniter 36 is connected to a power supply circuit of the vehicle via a connector and a lead wire (none is shown in the drawing). For the igniter 36, 260 mg of an ignition agent including zirconium and potassium perchlorate as the main components.

A first channel 37 located between the cylindrical housing 20 (inner space 22) and ignition device chamber 30 is blocked with a first rupturable plate 38 made from stainless steel, and the inside of the ignition device chamber 30 is under a normal pressure. The circumferential edge portion of the first rupturable plate 38 is fixed by welding to a first annular step surface 33 provided at the inner surface of the ignition device chamber housing 32.

In the diffuser portion 40, an outer shell is formed by a diffuser housing 42, and a plurality of gas discharge ports 46 for discharging the pressurized gas to the outside are uniformly arranged in the diffuser housing 42. In the gas generator shown in FIG. 1, a total of thirty gas discharge ports 46 each having a diameter of 1.5 mm are formed (total open surface area: 53 mm²).

A second channel 44 located between the cylindrical housing 20 (inner space 22) and diffuser portion 40 is blocked with a second rupturable plate 48 made from stainless steel, and the inside of the diffuser portion 40 is under a normal pressure. The circumferential edge portion of the second rupturable plate 48 is welded and fixed to the diffuser housing 42. The diameter (denoted by A in FIG. 1) of the second channel is 8 mm (cross-sectional area of the second channel is 50 mm²). A rod 24 is disposed inside the cylindrical housing 20 (inner space 22) to break the second rupturable plate 48.

A retainer 50 is disposed in a portion close to the diffuser portion 40 inside the cylindrical housing 20.

The retainer 50 shown in FIG. 2 has an annular frame portion 51 having a circumferential surface portion 52 and an annular surface portion 53, a plurality of rod-like support portions 54a, 54b, 54c, 54d extending toward the center from the annular surface portion 53 and a central support portion 55 having an orifice (through orifice) 56 and formed by linking to the rod-like support portions 54a to 54d. The retainer 50 is made from a metal such as stainless steel and aluminum or a synthetic resin and has elastic properties.

The retainer 50 has four opening portions 59 surrounded by the annular frame portion 51 (annular surface portion 53), central support portion 55, and rod-like support portions 54a, 54b, 54c, 54d. The total open surface area of the four opening portions 59 is 60 mm².

The diameter of the orifice 56 is less than the diameter of barb portion 24d of the rod 24, thereby preventing the rod 24 from moving in the axial direction prior to actuation. The central support portion 55 is a fragile portion and can be broken easier than other portions.

The retainer 50 is fitted (however, not press-fitted) into the cylindrical housing 20 or lightly press-fitted into the cylindrical housing 20 by making at least a portion of the outer diameter part of the circumferential surface portion 52 slightly larger than the inner diameter of the cylindrical housing 20. Lightly press-inserting the retainer 50 is preferred because the retainer 50 does not move during assembling, thereby ensuring good operability.

In accordance with the present invention, with the combination of the rod 24 and retainer 50, because they are fixed by pressing each other, even when they are press-inserted, the fixing strength may be less than that observed when a retainer is press-inserted in the conventional gas generator.

A circumferential edge portion 51a of the retainer 50 abuts against the diffuser housing 42, and the circumferential surface portion 52 abuts against an inner wall surface 21 of the cylindrical housing 20. The center of the orifice 56 and the center of the second rupturable plate 48 face each other. As a result, even if a force is applied, the retainer 50 does not move toward the second rupturable plate 48 and the rod 24 can be pushed toward the first rupturable plate 38.

In the gas generator shown in FIG. 1, when the retainer is arranged inside the cylindrical housing 20 in combination with the rod 24, the rod-like support portion 54a, etc., or the central support portion 55, or the annular frame portion 51 are deformed to be bent toward the second rupturable plate 48. Because the retainer 50 itself has elastic properties, the rod 24 is pushed towards the first rupturable plate 38 by the elastic force caused by the deformation of the rod-like support portion 54a, etc., or the central support portion 55, or the annular frame portion 51.

The retainer 50A shown in FIG. 3 is identical to the retainer 50 shown in FIG. 2 in terms of the basic shape and fixing mechanism of the rod 24, but differs in that it has three hooks 57 protruding inwardly inside the orifice 56. The diameter of the portions where the hooks 57 of the orifice 56 are absent is larger than the largest-diameter portion (barb portion 24d) of the rod 24, but the diameter of the portions containing hooks 57 is less than that of the barb portion 24d. As a result, the rod 24 is prevented by the three hooks 57 from moving in the axial direction prior to actuation.

The rod 24 has a disk-like portion (base portion) 24a, shaft portion 24b, and an arrowhead portion (distal reduced diameter portion) 24c; all the portions are integrated together and made from a metal such as stainless steel or aluminum.

In the arrowhead portion 24c of the rod, the diameter of the barb portion 24d is larger than the diameter of the orifice 56 of the retainer, and only part of the arrowhead portion protrudes toward the second rupturable plate 48 after being inserted without a gap into the orifice 56 (tight insertion). The distal end portion of the arrowhead portion 24c faces the center of the second rupturable plate 48 via a gap.

The disk-like portion 24a of the rod abuts against the second annular stepped surface 34 provided at the inner surface of the ignition device chamber housing 32. In the configuration shown in FIG. 1, the first rupturable plate 38 and disk-like portion 24a are separate components, but the disk-like portion 24a and first rupturable plate 38 may be formed integrally, or the disk-like portion 24a may also serve as the first rupturable plate 38.

The retainer 50 is fitted (or press-inserted) in a state where it comes into contact with the inner wall surface 21 of the cylindrical chousing 20 and the diffuser housing 42 and then the arrowhead portion 24c of the rod 24 is tightly inserted into the orifice 56 of the retainer shown in FIG. 2 or FIG. 3. As a result, the rod 24 and retainer 50 are pushed against each other and the second annular stepped surface 34 of the ignition device chamber housing 32 is pressed by the disk-like portion 24a of the rod.

As a result, because the rod 24 and retainer 50 become sandwiched between the ignition device chamber housing 32 and diffuser housing 42, both the retainer 50 and the rod 24 are fixed in the predetermined position, and not only the rod 24 is prevented from shaking under the effect of vibrations, etc., induced from the outside, but also the retainer 50 itself is prevented from shaking or falling off.

Even when the retainer 50 is fitted, not press-inserted, into the cylindrical housing 20, or when the retainer 50 is press-inserted, but the fixing strength created by press-inserting is small, the above-described combination of the rod 24 and retainer 50 makes it possible to obtain a fixing strength identical to that attained when the retainer is tightly press-inserted. It goes without saying that the retainer may be tightly press-inserted in the same manner as in the conventional gas generators and in this case the fixing strength is further increased.

The operation of the gas generator 10 shown in FIG. 1, FIG. 2, and FIG. 3 in the case where it was assembled with an air bag system of an automobile will be described below. In the gas generator 10, the igniter 36 from which a lead wire is led out and the gas discharge port 46 where the air bag is attached are located on the opposite sides. Therefore, the lead wire does not become an obstacle during the air bag attachment operation.

When an automobile collides and receives an impact, an actuation signal is received from a control unit, the igniter 36 is actuated and ignited, the first rupturable plate 38 is broken by the generated shock wave, and the first channel 37 is opened. The shock wave that has broken the first channel 37 then hits and pushes the disk-like portion 24a of the rod.

As a result, the rod 24 moves in the axial direction. In the retainer 50 shown in FIG. 2, the arrowhead portion 24c inserted into the orifice 56 breaks the central support portion 55, advances linearly forward, and hits the second rupturable plate 48. In the retainer 50A shown in FIG. 3, the arrowhead portion 24c inserted into the orifice 56 breaks the three hooks 57, moves linearly forward, and hits the second rupturable plate 48. Under the impact of the arrowhead portion 24c, the second rupturable plate 48 is broken, the second channel 44 is opened, the pressurized gas is released from the gas discharge port 46, and the air bag is inflated. In the configuration illustrated by FIG. 2, the orifice 56 itself is a fragile portion and the distal end of the arrowhead portion 24c passes therethrough before actuation. Therefore, the rod 24 is moved easily by the actuation of the igniter 26.

The outer peripheral surface of the disk-like portion 24a of the rod may abut against the inner peripheral surface of the cylindrical housing 20 to be pressed toward the ignition device chamber housing 32 by the retainer 50. In this case, positioning of the rod 24 in the radial direction is conducted by the abutment (not press-contacting) of the outer peripheral surface of the disk-like portion 24a of the rod and the inner peripheral surface of the cylindrical housing 20, and the rod 24 is fixed in the axial direction by the retainer 50 and ignition device chamber housing 32.

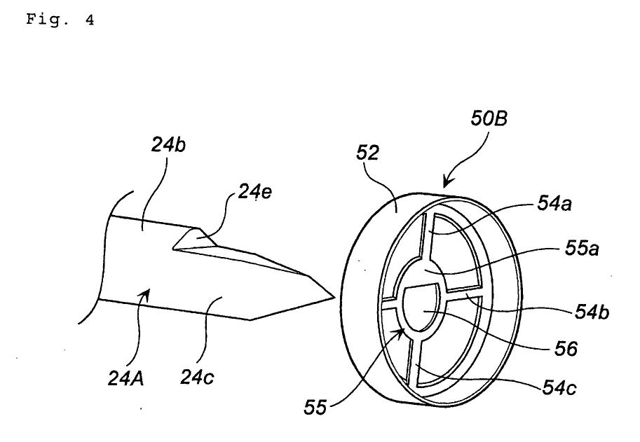

(2) Gas Generator Shown in FIG. 4

FIG. 4 is a perspective view of a configuration obtained by modifying the shape of the distal end portion of the rod and the shape of the retainer orifice in connection with each other in the gas generator shown in FIG. 1.

The diameter of the arrowhead portion 24c of the rod 24A is less than that of the shaft portion 24b, and a vertical wall surface 24e is provided between the shaft portion 24b and arrowhead portion 24c.

In a central support portion 55 of a retainer 50B, an inhibit surface 55a serving as a fragile portion is provided together with the orifice 56. The orifice 56 has the same shape as the arrowhead portion 24c and allows the arrowhead portion 24c to be tightly inserted therein.

When the arrowhead portion 24c of the rod 24A is inserted into the orifice 56 of the retainer 50, the vertical wall surface 24e abuts against the inhibit surface 55a, thereby preventing the arrowhead portion from being further inserted. Because the vertical wall surface 24e abuts against the inhibit surface 55a, the rod 24A is prevented from moving in the axial direction prior to actuation. At the time of actuation, the inhibit surface 55a is broken, the rod 24A moves in the axial direction, and the second rupturable plate 48 shown in FIG. 1 is broken. The rod-like support portions 54a, etc., or the central support portion 55, or the annular frame portion 51 are deformed, an elastic force is generated, and the rod 24 is pressed toward the first rupturable plate 38 by the vertical wall surface 24e abutting against the inhibit surface 55a, in the same manner as in the above-described embodiment.

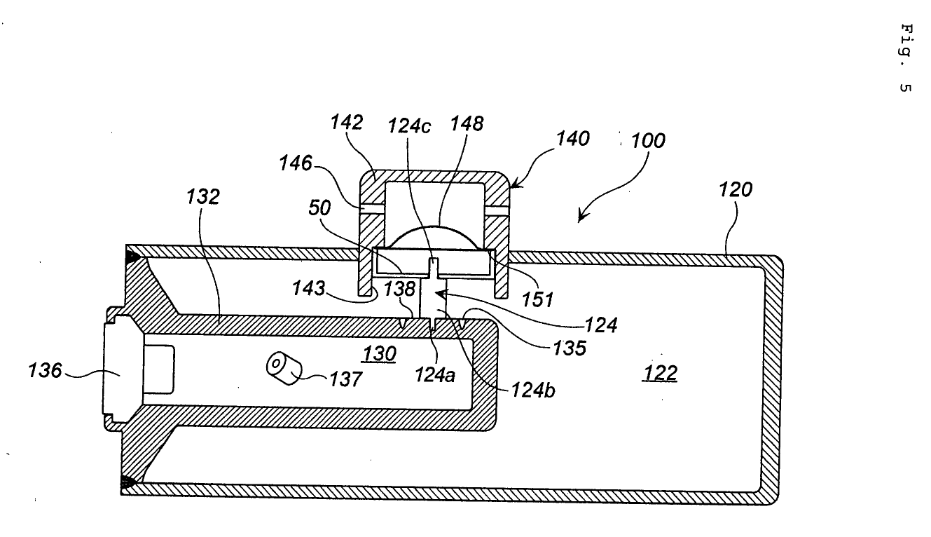

(3) Gas Generator Shown in FIG. 5

FIG. 5 is a longitudinal sectional view of the gas generator for an air bag. The gas generator for an air bag shown in FIG. 5 is of a hybrid system using a pressurized gas together with a combustion gas of a gas generating agent as the air bag inflation means.

A cylindrical housing 120 has two opening portions on one end and a circumferential surface, an ignition device chamber 130 connected to the opening portion at one end, and a diffuser portion 140 connected to the opening portion in the circumferential surface. Those components are made from stainless steel or aluminum, and fixed by welding in the respective joint portions thereof.

The inside of the inner space 122 of the cylindrical housing 120 is maintained in an air-tight state and filled with a single gas such as argon, helium or nitrogen or a gas mixture thereof (charging pressure is about 35,000-70,000 kPa). The pressurized gas preferably has a sound velocity of 400 m/sec or more at a temperature of 0° C. and under a pressure of 1 atm (101.325 kPa). The pressurized gas is charged from a charging hole before it is blocked with a pin (not shown in the figure), and then sealing is conducted by welding the pin and cylindrical housing 120 together.

The ignition device chamber (also functions as a combustion chamber) 130 has an outer shell formed by an ignition device chamber housing 132. An electric igniter 136 provided with an ignition agent and a gas generating agent 137 are accommodated inside the ignition device chamber housing 132. The igniter 136 is connected to a power supply circuit of the vehicle via a connector and a lead wire (none is shown in the drawing).

V-shaped notches 135 are formed as a broken line so as to obtain a round planar shape in part of the circumferential surface of the ignition device chamber housing 132, the inner portion surrounded by V-shaped notches 135 serves as a fragile portion, and a first rupturable plate 138 is formed. As a result, the cylindrical housing 120 (inner space 122) and the ignition device chamber 130 are not communicated prior to actuation, and communication therebetween is established when the first rupturable plate 138 is broken during actuation.

In the diffuser portion 140, an outer shell is formed by a diffuser housing 142, and a plurality of gas discharge ports 146 for discharging the pressurized gas to the outside are uniformly arranged in the diffuser housing 142.

A second rupturable plate 148 made from stainless steel blocks between the cylindrical housing 120 (inner space 122) and diffuser portion 140, and the inside of the diffuser portion 140 is under a normal pressure. The circumferential edge portion of the second rupturable plate 148 is welded and fixed to a stepped surface 151 located inside the diffuser housing 142.

A retainer 50 is disposed inside the diffuser portion 140. The retainer 50 is identical, with the exception of size, to the retainer shown in FIG. 2.

The retainer 50 is fitted (not press-inserted) into the diffuser housing 142 or lightly press-inserted into the diffuser housing 142 by making at least a portion of the outer diameter part of the circumferential surface portion 52 slightly larger than the inner diameter of the diffuser housing 142.

A circumferential edge portion 51a of the retainer 50 abuts against the stepped surface 151, and the circumferential surface portion 52 abuts against an inner wall surface 143 of the diffuser housing 142. The center of the orifice 56 and the center of the second rupturable plate 148 face each other.

A rod 124 for breaking the second rupturable plate 148 is disposed inside the cylindrical housing 120. The rod 124 has a base reduced diameter portion 124a of a round columnar shape, a shaft portion 124b, and a distal reduced diameter portion 124c of a round columnar shape; all the portions are integrated together and made from a metal such as stainless steel or aluminum.

The diameter of the distal reduced diameter portion 124c enables the insertion into the orifice 56 of the retainer, and the diameter of the shaft portion 124b of the rod is larger than the diameter of the orifice 56 of the retainer. Therefore, only the distal reduced diameter portion 124c is inserted into the orifice 56 and protrudes toward the second rupturable plate 148, and the end surface of the shaft portion 124b presses against the central support portion (fragile portion) 55. The distal end portion of the distal reduced diameter portion 124c faces the center of the second rupturable plate 148 via a gap.

The base reduced diameter portion 124a of the rod is tightly fitted into a hole (not a through-hole) provided in the central portion of the first rupturable plate 138 of the ignition device chamber housing 132.

The retainer 50 that is in contact with the inner wall surface of the diffuser housing 142 is fitted (or press-inserted), the distal reduced diameter portion 124c of the rod 124 is then inserted into the orifice 56 of the retainer shown in FIG. 2, and the central support portion (fragile portion) 55 is pushed by the end surface of the shaft portion 124b.

As a result, because the retainer 50 and rod 124 become sandwiched between the ignition device chamber housing 132 and diffuser housing 142, both the retainer 50 and the rod 124 are fixed in the predetermined position, and not only the rod 124 is prevented from shaking under the effect of vibrations, etc., induced from the outside, but also the retainer 50 itself is prevented from shaking or falling off.

The operation of the gas generator 100 shown in FIG. 5 and FIG. 2 in the case where it was assembled with an air bag system of an automobile will be described below. In the gas generator 100, the igniter 136 from which a lead wire is led out and the gas discharge port 146 where the air bag is attached are located in the orthogonal directions. Therefore, the lead wire does not become an obstacle during the air bag attachment operation.

When an automobile collides and receives an impact, an actuation signal is received from a control unit, the igniter 136 is actuated and ignited, the gas generating agent 137 is ignited and combusted, and the combustion gas is generated. The combustion gas generation rises pressure inside the ignition device chamber housing 130. As a result, the first rupturable plate 138 is broken by the generated shock wave and the entire rod 124 is pushed.

The rod 124 moves in its axial direction, breaks the central support portion 55 of the retainer 50, and advances linearly forward, and the distal reduced diameter portion 124c hits the second rupturable plate 148. The second rupturable plate 148 is broken by the impact of the distal reduced diameter portion 124c, the combustion gas and pressurized gas are discharged from the gas discharge port 146, and the air bag is inflated.

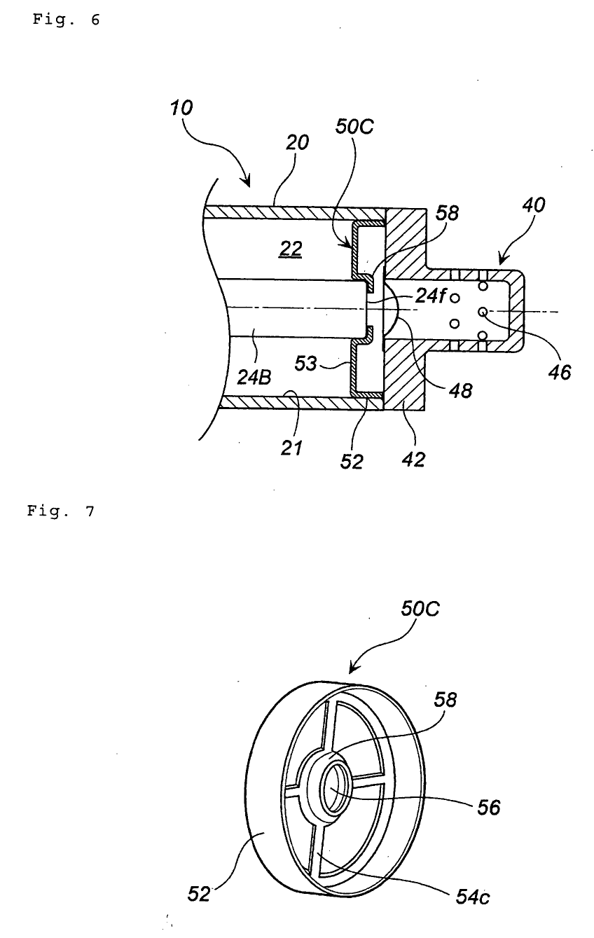

(4) Gas Generator Shown in FIG. 6 and FIG. 7

FIG. 6 is a longitudinal partial sectional view of a gas generator 10 for an air bag. FIG. 7 is a perspective view of the retainer shown in FIG. 6. The gas generator shown in FIG. 6 is identical to the gas generator 10 shown in FIG. 1, except that the shape of the distal end portion of a rod 24B and the shape of the orifice 56 of the retainer 50C are different. This gas generator is of a stored-gas type using a pressurized gas as the air bag inflating means.

The entire rod 24B has the same diameter, and a distal end surface 24f has a flat surface. In the retainer 50C, the circumferential edge of the orifice 56 is raised and an inward flange portion (serving as a fragile portion) 58 is provided. The circumferential edge portion of the distal end surface 24f is pressed against the inward flange portion 58.

The retainer 50C that is in contact with the inner wall surface 21 of the cylindrical housing 20 and the diffuser housing 42 is fitted (or press-inserted), and the distal end surface 24f of the rod 24 is pressed against the inward flange portion 58 of the retainer. Therefore, as shown in FIG. 1, the opposite end portion of the rod 24 presses against the second annular stepped surface 34 of the ignition device chamber housing 32.

As a result, because the rod 24 and the retainer 50 become sandwiched between the ignition device chamber housing 32 and diffuser housing 42, both the rod 24 and the retainer 50 are fixed in the predetermined position, and not only the rod 24 is prevented from shaking under the effect of vibrations, etc., induced from the outside, but also the retainer 50 itself is prevented from shaking or falling off.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator for a restraining device of a vehicle, comprising:
a cylindrical housing having two opening portions,
an ignition device chamber connected to one opening portion of the cylindrical housing,
a diffuser portion connected to the other opening portion of the cylindrical housing and having a gas discharge port,
a first blockage member blocking between the cylindrical housing and the ignition device chamber,
a second blockage member blocking between the cylindrical housing and the diffuser portion,
a pressurized gas charged inside the cylindrical housing,
a rod disposed inside the cylindrical housing and breaking the second blockage member to open a path to the diffuser portion during activation, the rod including
a base portion being in contact with a wall surface near the first blockage member, and
a distal end portion being in contact with and supported by a retainer which is fitted into a position near the second blockage member, the distal end portion and the retainer being fixed by pressing against each other due to the distal end portion contacting and supported by the retainer, the base portion of the rod being fixed by pressing against the wall surface near the first blockage member due to the distal end portion of the rod and the retainer fixing to each other.

2. The gas generator for a restraining device according to claim 1, wherein
the retainer has at least one orifice or recess, and
the distal end portion of the rod is inserted into the orifice or recess of the retainer, whereby the distal end portion of the rod and the retainer are fixed by pressing against each other, and the distal end portion of the rod and the retainer are fixed to each other, whereby the base portion of the rod is pressed against and fixed to the wall surface in the vicinity of the first blockage member.

3. The gas generator for a restraining device according to claim 1, wherein
the rod has a shaft portion and a distal end portion, and the distal end portion of the rod has a reduced diameter portion having a diameter smaller than that of the shaft portion of the rod, and
the rod is inserted into the orifice or recess of the retainer so that only the reduced diameter portion protrudes toward the diffuser portion, and the remaining portion of the rod is pressed against the orifice or recess of the retainer, whereby the distal end portion of the rod and the retainer are fixed by being pressed against each other, and the distal end portion of the rod and the retainer are fixed to each other, whereby the base portion of the rod is pressed against and fixed to the wall surface in the vicinity of the first blockage member.

4. The gas generator for a restraining device according to claim 1, wherein the retainer has an annular frame portion, a plurality of rod-like support portions extending toward a center from a peripheral edge on one end side of the annular frame portion, and a central support portion formed by the plurality of support portions and having an orifice or a recess, wherein a circumferential surface of the annular frame portion is in contact with an inner wall surface of the cylindrical housing.

5. A gas generator for a restraining device of a vehicle, comprising:
a cylindrical housing having two opening portions,
an ignition device chamber connected to one opening portion of the cylindrical housing,
a diffuser portion connected to the other opening portion and having a gas discharge port,
a first channel being formed between the cylindrical housing and the ignition device chamber and blocked by a first blockage member,
a second channel being formed between the cylindrical housing and the diffuser portion and blocked by a second blockage member,
a pressurized gas being charged inside the cylindrical housing,
a rod being disposed inside the cylindrical housing and breaking the second blockage member to open a path to the diffuser portion during activation, the rod including,
a base portion being in contact with a wall surface near the first blockage member, and
a distal end portion being in contact with and supported by a retainer which is fitted into a position near the second blockage member,
a retainer including an annular flame portion abutting against an inner circumferential surface of the cylindrical housing, and a central support portion abutting against the distal end portion of the rod, and a rod-like support portion connecting the annular flame portion with the central support portion,
the rod being, fixed in a state of contacting the retainer by the distal end thereof and the retainer pressing against each other due to elastic deformation of at least one portion among the annular flame portion, the central support portion and rod-like support portion, further, the base portion of the rod being pressed against and fixed to a wall surface near the first blockage member by the distal end portion of the rod and the retainer fixed to each other.

6. The gas generator for a restraining device according to claim 5, wherein the central support portion has at least one orifice or recess, and the distal end portion of the rod is inserted into the orifice or recess of the central support portion, whereby the distal end portion of the rod and the retainer are fixed by being pressed against each other, and because the distal end portion of the rod and the retainer are fixed to each other, the base portion of the rod is pressed against and fixed to the wall surface in the vicinity of the first blockage member.

7. The gas generator for a restraining device according to claim 5, wherein a total open surface area of an opening portion surrounded by the central support portion, the annular frame portion, and the rod-like support portion is larger than a total open surface area of the gas discharge port formed in the diffuser and a cross-sectional area of the second channel.
